(19) United States
(12) Patent Application Publication
(10) Pub. No.: US 2021/0364442 A1
(43) Pub. Date: Nov. 25, 2021

(54) RAMAN PHOTONIC CHIPS FOR CHEMICAL AND BIOLOGICAL SENSING

(71) Applicant: The Texas A&M University System, College Station, TX (US)

(72) Inventor: Pao Tai Lin, College Station, TX (US)

(21) Appl. No.: 17/325,109

(22) Filed: May 19, 2021

Related U.S. Application Data
(60) Provisional application No. 63/027,103, filed on May 19, 2020.

(51) Int. Cl. G01N 21/65; G01J 3/44

(52) U.S. Cl. CPC G01N 21/658; G01J 3/4412

(57) ABSTRACT

Raman spectroscopy of chemical and biological samples can be accomplished with photonic sensors amenable to chip-scale integration. In various embodiments, such a photonic sensor includes first and second optical waveguides coupled via an optical ring resonator, the ring resonator configured to resonantly enhance, and selectively couple into the second optical waveguide, a Raman scattering signal generated, when the first waveguide and/or resonator are exposed to a sample, by interaction of an analyte in the sample with excitation light coupled into the first optical waveguide.

### PRIORITY

This application claims the benefit of priority to U.S. Provisional Application Ser. No. 63/027,103, filed May 19, 2020, which are incorporated by reference herein in their entirety.

### TECHNICAL FIELD

The present disclosure relates generally to integrated photonics. More specifically, various embodiments relate to photonics-based chemical, biochemical, or biological sensors.

### BACKGROUND

Chemical and biological sensing systems routinely employ spectroscopic methods for the detection, analysis, and/or quantification of analytes. Many chemical identification and characterization methods, for example, take advantage of the fact that numerous chemical functional groups have characteristic absorption bands and absorption patterns (called “fingerprints”) in the IR spectrum that allow determining, or at least narrowing the possibilities for, the types of molecules present in a sample. A common laboratory instrument used for IR absorption spectroscopy is a Fourier transform infrared (FTIR) spectrometer. FTIR spectrometers are benchtop-size apparatus that generally test one sample at a time, are not easily portable, and, as a result, cannot be easily used in the field.

As another example, in the field of molecular diagnostics, fluorescence spectroscopy is often used in testing biological samples, such as blood, urine, or tissue, for the presence or concentration of biological markers in the genome or proteome that are indicative of certain diseases. A genetic disease marker having a certain deoxyribonucleic acid (DNA) or ribonucleic acid (RNA) sequence, for example, can be detected by exposing the sample to a fluorescently labeled biological probe including the complementary sequence, exploiting a change in fluorescence upon binding of the disease marker to the probe. Typically, such fluorescent-based DNA or RNA detection is used in conjunction with polymerase chain reaction (PCR) or reverse-transcript PCR (RT-PCR) to selectively amplify the target DNA or RNA sequence, which may occur in the initial in too low a concentration. Fluorescence-based (RT-)PCR, and other molecular diagnostics methods, usually involves complex processes and equipment, and are therefore conventionally performed in centralized medical laboratories, which entails substantial cost as well as delay between the time the sample is taken from a patient and the time the results are available.

### BRIEF DESCRIPTION OF THE DRAWINGS

Disclosed herein is a photonic sensing platform that facilitates Raman spectroscopy of chemical and biological samples. Various aspects and example embodiments are described with reference to the accompanying drawings, in which:

FIG. 1 is a schematic perspective view of a waveguide-based Raman photonic sensor in accordance with various embodiments, illustrating its principle of operation;

FIG. 2A is a schematic perspective view of a waveguide-based Raman photonic biosensor in accordance with various embodiments;

FIG. 2B is a schematic cross section of the waveguide-based Raman photonic biosensor of FIG. 2A;

FIG. 3 shows a series of scanning electron microscopy (SEM) images of an example Raman photonic chip, in accordance with various embodiments, at three successively increasing magnifications.

FIG. 4 is a block diagram of a Raman spectroscopy system, in accordance with various embodiments;

FIG. 5 is a cut-away perspective view of a waveguide-based sensor enclosed in a microfluid chamber in accordance with various embodiments;

FIG. 6 is a flow chart of a method for Raman-based sensing in accordance with various embodiments;

FIG. 7 is a schematic cross section of a waveguide-based biosensor incorporating a slot waveguide, in accordance with various embodiments;

FIG. 8 is a sequence of cross-sectional views of a slot waveguide, as may be used in Raman photonic sensors as described herein, illustrating an example method of manufacturing the slot waveguide, in accordance with various embodiments;

FIG. 9A-9E are top views of example nano-slot waveguide structures in accordance with an embodiment;

FIG. 10A is a cross-sectional view of a strip waveguide as may be used in Raman photonic sensors in accordance with various embodiments;

FIGS. 10B and 10C show example optical modes in the strip waveguide of FIG. 10A in two dimensions for transverse electric (TE) and transverse magnetic (TM) polarizations, respectively;

FIGS. 10D and 10E are example one-dimensional profiles of the field distribution associated with the optical modes of FIGS. 10B and 10C, respectively;

FIG. 11A is a cross-sectional view of a nano-slot waveguide as may be used in Raman photonic sensors in accordance with various embodiments;

FIGS. 11B and 11C show example optical modes in the nano-slot waveguide of FIG. 11A in two dimensions for transverse electric (TE) and transverse magnetic (TM) polarizations, respectively;

FIGS. 11D and 11E are example one-dimensional profiles of the field distribution associated with the optical modes of FIGS. 11B and 11C, respectively.

### DESCRIPTION

Disclosed herein are photonic, waveguide-based sensors, and associated sensing systems and methods, that enable Raman spectroscopy of chemical and biological samples. The photonic sensors are amenable to chip-scale integration, which provides cost savings and the potential to integrate many sensors into arrays for high-throughput testing. Applied to the detection of molecular disease markers, these chip-scale photonic sensors can, in some embodiments, enable moving diagnostics from centralized laboratories to the point of care (that is, the time and place of patient care).

The term “chemical” is hereinafter used broadly in reference to any organic or inorganic chemical substance, and is intended to encompass, without being limited to, biochemicals, that is, substances occurring within living organisms and/or relating to biological processes. Accordingly, “chemical sensors” and “chemical sensing methods” described herein are also intended to include biochemical sensors and biochemical sensing methods. The term “biological” is hereinafter used in reference to biologically active organic molecules, including, without limitation, polynucleic acids (e.g., DNA or RNA) and proteins.

Raman spectroscopy, as is used in the disclosed sensing method, takes advantage of light interactions with molecules in which the incoming light causes transitions between vibrational and/or rotational modes that cause light emission at wavelengths different from the excitation wavelength, a phenomenon called Raman scattering. The shifts in wavelength (which may include shifts to longer wavelengths in “Stokes” Raman scattering, as well as shifts to shorter wavelengths in “anti-Stokes” Raman scattering) provide information about the vibrational and/or rotational mode of the molecules. The wavelength(s) of Raman-scattered light relative to the excitation wavelength, thus, can provide a characteristic “fingerprint” of a molecule (much like the characteristic absorption bands) that allows identifying, or narrowing down the possibilities, for the type of molecule.

In accordance with various embodiments, the characteristic Raman scattering is used to detect and identify chemical or biological analytes in a sample brought in contact with the waveguide-based sensor. Further, in some embodiments, the waveguide-based sensor is surface-functionalized with a suitable probe layer to bind to a specific analyte. The sensor may, for instance, be a biosensor that includes a biological probe layer to specifically bind to a certain biological analyte (herein also “target”). Examples of biological targets include oligonucleotides (short DNA or RNA molecules) and proteins like enzymes, antibodies, or antigens. When the target is bound to the probe, the Raman scattering spectrum generally differs from that observed in the absence of the target, facilitating target detection. The specificity of the biological probe to the target allows isolating the target from any background in the sample by cleaning the sensor surface once the target is bound to the surface. As a result, the disclosed photonic biosensors may enable detecting even small concentrations of the target in the sample that is initially applied to the sensor; in other words, the sensitivity for target detection is high. In the context of detecting oligonucleotides, the high sensitivity may, in some embodiments, allow omitting amplification steps like PCR or RT-PCR.

Example Raman photonic sensors and sensing systems will now be described with reference to the accompanying drawings.

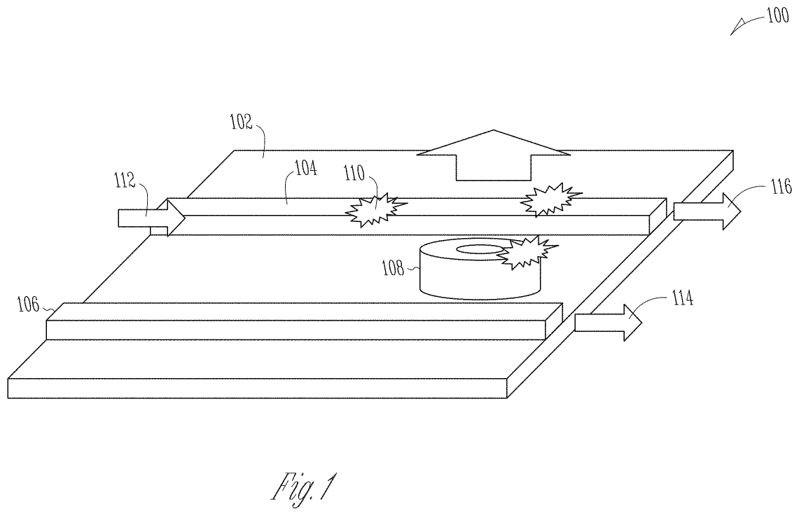

FIG. 1 is a schematic perspective view of an example waveguide-based Raman photonic sensor 100 in accordance with various embodiments, illustrating its principle of operation. The sensor 100 includes, on a substrate 102 (e.g., a layered substrate including a cladding layer on top of a handle layer), two optical waveguides 104, 106 coupled to each other by an optical ring (e.g., micro-ring) resonator 108. A photonic crystal resonator could also be used to couple the two optical waveguides, 104, 106. The ring resonator 108 is sufficiently close to both waveguides 104, 106 so that the evanescent fields of optical modes guided in the waveguides 104, 106 extend into the ring resonator 108, and vice versa, allowing light to couple back and forth between the ring resonator 108 and each of the waveguides 104, 106. The ring resonator 108 resonantly enhances light at any wavelength for which the optical path length of a round trip along the ring resonator 108, that is, the product of the geometric round-trip length (circumference) and the refractive index of the ring resonator 108, is an integer multiple of the wavelength. Light propagating along the first waveguide 104 (which is herein, arbitrarily, used as the input waveguide) is coupled via the ring resonator 108 into the second waveguide 106 (serving as the output waveguide) if and only if its wavelength corresponds to one of the resonance wavelengths of the ring resonator 108. The ring resonator 108 can thus act as a wavelength-selective filter that extracts light at any of its resonance wavelengths from the first waveguide 104 and outputs it to the second waveguide 106.

To use the photonic sensor 100 for Raman-based detection of chemical or biological analyte(s) in a sample, at least a portion of the first waveguide 104 (which is herein, arbitrarily, used as the input waveguide) and/or of the ring resonator 108 is exposed to the sample. Molecules 110 in the sample can interact, in the vicinity of the waveguide 104 or ring resonator 108, with the evanescent field of the guided light to create Raman-scattered light. For a given wavelength of the excitation light 112 input to the first waveguide 104, a given analyte (that is, substance of interest) scatters at one or more known Raman wavelengths. In accordance with various embodiments, the ring resonator 108 is configured, in terms of its geometry and materials, to have a resonance coinciding with a Raman scattering wavelength of the analyte for the given excitation wavelength. Thus, if the excitation light 112 in the waveguide 104 interacts with the analyte, the resulting Raman scatter signal will be coupled via the resonator 108 into the second, output waveguide 106. Similarly, if the excitation light 112 couples into the ring resonator 108 and interacts with analyte on the resonator 108, generating a Raman scatter signal at the resonance wavelength, that signal will be resonantly enhanced and coupled, at least in part, into the output waveguide 106, or back to the first waveguide 104. The Raman-scattered light 114 created by the analyte can be measured at the output of the second waveguide 106, or where it is coupled to the first waveguide 104 at the output of the first waveguide 104. The excitation light 112 and any Raman-scattered light at non-resonant wavelengths (e.g., created by substances other than the analyte for which the ring resonator 108 is designed), collectively 116, will be transmitted to the output of the first waveguide 104.

Describing the structure of the Raman photonic sensor in more detail, the waveguides 104, 106 may be a strip waveguide with a rectangular cross section, but other cross-sectional shapes and waveguide types (e.g. rib waveguides, slab waveguides, nano-slot waveguides, etc.) are also possible. Similarly, the ring resonator 108 may have a strip-waveguide cross-sectional profile. The cross sections of waveguides 104, 106 and ring resonator 108 may have heights between 200 nm and 1 μm, and widths between 0.5 μm and 3 μm. In one example embodiment, the cross sections have dimensions of 0.8 μm×0.8 μm. The ring resonator may have dimensions on the order of a few micrometers, e.g., a radius between 2 and 5 μm. While the ring resonator depicted in FIG. 1 is circular, other ring shapes (e.g., elliptical) are also possible.

In some embodiments, the optical ring resonator 108 has adjustable resonances. For example, the ring resonator 108 may be configured as or include an electro-optic modulator, which allows changing the refractive index of the resonator 108, and thus the optical path length of one round-trip, by application of an electrical field. Similarly, the ring resonator 108 may be equipped with a nearby heater that changes the refractive index via the thermo-optic effect. By adjusting the resonance wavelength of the resonator 108, the sensor can be tuned to different Raman scattering wavelengths, allowing multiple wavelengths within the Raman spectrum of analyte, or Raman scattering wavelengths associated with multiple analytes, to be detected. Alternatively, it is also possible to couple multiple ring resonators with different respective resonances between the input waveguide 104 and the output waveguide 106 (creating a serial ring resonator structure), or between the input waveguide 104 and multiple separate output waveguides, to extract multiple Raman scattering signals. If combined in a single output waveguide 106, the different Raman signals can be spread out via suitable dispersive elements. Further, with a fixed resonance, it is possible to capture different Raman wavelength shifts by scanning the excitation wavelength across a range.

The Raman photonic sensor 100 can be implemented in various material platforms, selected, e.g., based on the wavelengths at which the sensor operates to achieve strong confinement and high transparency to light at the operating wavelengths. In various embodiments, operating wavelengths are in the visible or IR regime. In some use cases, the excitation wavelength is in the visible range between 532 and 785 nm, and the resulting Raman-scattered light may be in the visible to near-IR regime from about 700 nm to about 1 μm. Suitable materials for the waveguide and resonator structures include, without limitation, aluminum nitride (AlN), silicon nitride (SiN), titanium oxide (TiO₂) and Oxide (O₂) as the undercladding with silicon (Si) as the substrate. In general, the waveguides and ring resonator can be created in a suitably layered wafer using standard CMOS processes, including combinations of (e.g., photolithographic) patterning and etching. For example, in an AlN on . . . platform, the top AlN device layer of the wafer can be photolithographically patterned to define the waveguide (with photoresist covering the area where the waveguide is to be formed), and then etched to remove the AlN in areas surrounding the waveguide.

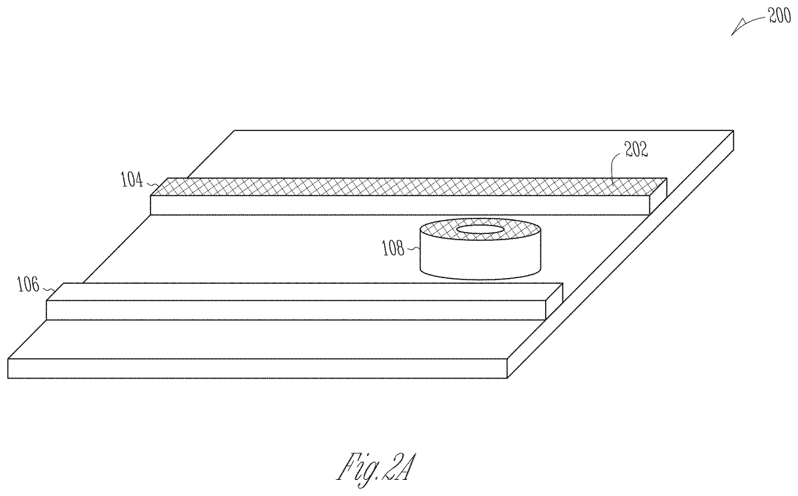

FIGS. 2A and 2B provide schematic perspective and cross-sectional views, respectively, of a waveguide-based Raman photonic biosensor 200 in accordance with various embodiments. The biosensor 200 is structurally similar to the sensor 100 shown in FIG. 1, but additionally includes a biological probe layer 202 on the first waveguide 104, the ring resonator 108, or, as shown, both. In some embodiments, the waveguide 104 and/or resonator 108 are first coated by a thin adhesion layer 204, and the biological probe layer 102 is then disposed on top of the adhesion layer 204. The adhesion layer 204 may be made of a material with two chemical functional groups that can bond to the waveguide surface and to the biological probe forming the probe layer 202, respectively. In some embodiments, the adhesion layer 204 is made from a reactive silane, e.g., of the formula R¹—Si(OR²)₃, wherein R¹ is an aminoalkyl group and each R² is, independently, a (C₁-C₆)alkyl group; in one example, the reactive silane is or includes (3-aminopropyl)trimethoxysilane (APTMS). The adhesion layer 204 may be applied to the waveguide surface by spin-coating.

The biological probe layer is made up of biological molecules (e.g., proteins or polynucleic acid) that act as a biological “capture agent” in that they will selectively bond to the targeted analyte (e.g., molecules 110) when the coated waveguide or resonator is wetted with a sample including the analyte. To create the probe layer 202 on top of the adhesion layer 204, a solution including the biological probe or capture agent (herein used synonymously) is applied to the adhesion layer (e.g., by simply creating a drop of the solution on top of the adhesion layer), and the biological probe then binds (on its own) to the adhesion layer 202. Application of the biological probe on top of the adhesion layer 204 may form a reaction product bound to the waveguide surface. Alternatively to adhering the biological probe to the waveguide via an adhesion layer 204, the probe layer 202 may also be formed directly on the waveguide surface, e.g., bonding with the surface due to electrostatic forces, and the adhesion layer 204 may, accordingly, be omitted. To facility such direct bonding, the waveguide surface and/or the solution including the biological probe may be pre-modified. For example, the pH of the probe solution may be adjusted to encourage bonding of the biological probe to the waveguide. The thickness of the probe layer 202, or the adhesion layer 204 and probe layer 202 together, may be in the sub-nanometer range, or up to a few hundred nanometers (e.g., 400 nm), depending on the type of biological probe used.

The capture agent that makes up the probe layer 202 is selected, based on the application, to bind specifically to the target. The capture agent may, for instance, bond to biological moieties located on the surface of viruses, bacteria, or fungi. For example, in some embodiments, the target is an antigen, and the capture agent includes the associated antibody. In other embodiments, the target is a DNA or RNA molecule associated with a specific gene, and the capture agent includes DNA having the complementary nucleotide sequence. In one example embodiment, the biological probe is made from proteins or DNA that will only bond to a target, such as DNA or antibodies, related to a coronavirus (e.g., SARS-CoV-1, which caused the SARS outbreak in 2003, or SARS-CoV-2, which caused the current COVID-19 pandemic starting in 2019). For example, the probe may be the DNA sequence 5′ GGT CCA CCA AAC GTA ATG CGG GGT-3′, which serves as the capture agent for the 2019-nCoV N1 marker gene.

To use the biosensor 200 to test a liquid sample (e.g., a blood, saliva or urine sample taken from a patient, or a sample prepared from a tissue specimen taken from the patient) for the target, the biosensor 200 is first wetted by the liquid sample, and the sensor surface is thereafter cleaned (e.g., rinsed with water), leaving only molecules that can bind to the probe—by design ideally only the target—bound to the sensor surface. The Raman scattering signals will generally differ between samples with and without the target, and the biosensor 200 may be configured such that the resonance of the ring resonator 108 matches only the wavelengths of Raman-scattered light generated in the presence of the target.

FIG. 3 shows a series of scanning electron microscopy (SEM) images of an example Raman photonic chip, in accordance with various embodiments, at three successively increasing magnifications. The chip at large, shown on the left, includes an array of eight Raman photonic sensors as described above. On the right, a zoomed-in view of an individual sensor 300 can be seen. In this example, the ring resonator 302 has an elongate, “race track” oval shape with sections running parallel to the input and output waveguides 304, 306. The input waveguide 304 tapers down, in a tapered region 308, from a greater width of the incoming waveguide to a smaller width of the waveguide section directly adjacent the ring resonator 302, where the sample will be applied. Similarly, the output waveguide 306 tapers up, in two successive tapered regions 310, from a narrower section directly adjacent the ring resonator 302 to a wider output waveguide portion.

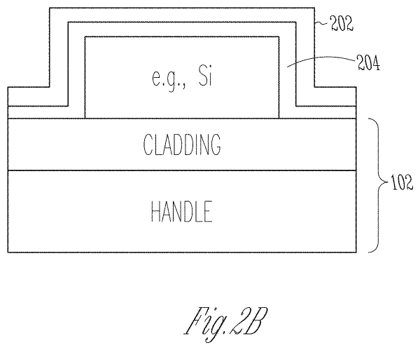

FIG. 4 is a block diagram of a Raman spectroscopy system 400, in accordance with various embodiments, that integrates a Raman photonic sensor as described above. The system 400 includes, in addition to the waveguide-based Raman-photonic sensor 402 itself (e.g., sensor 100 or biosensor 200), a light source 404 (e.g., a laser) coupling light, directly or indirectly, into the sensor 402, and a detector 406 measuring the light exiting the second waveguide 106. The light source 404 may generate monochromatic light. In some embodiments, the light source 404 is tunable, which allows changing the excitation wavelength and thereby the Raman shift between excitation wavelength and Raman scattering wavelength that is observable at the output of the second waveguide 106. In systems configured to couple light at only a single wavelength into the second waveguide 106, the detector 406 may be a single photodetector sensitive to light within the operating wavelength range. Similarly, in system configured to couple Raman scattering signals at multiple wavelengths into multiple respective output waveguides, each output may be measured with a single detector. On the other hand, if multiple Raman scattering signals are coupled into the same output waveguide 106 (e.g., using series micro-ring resonators), the different wavelengths may be spread out spatially (e.g., using micro-resonators or photonic crystals as dispersive elements), and using a camera or array of sensors to measure the light at different locations, or moving a single detector to the different locations.

The light emitted by the light source 404 may be collimated, e.g., with a refractive lens, into an optical fiber, which may then be butt-coupled to the waveguide sensor 402. Similarly, the light output by the waveguide sensor 402 may be focused by a lens onto the camera or other detector 406. Alternatively, the light source 404 and/or detector 406 may be implemented as photonic-circuit components and monolithically integrated with the sensor 402 on the same substrate. Lasers and detectors may be formed, e.g., by semiconductor device structures (which may be created in the same layer, and using the same or similar methods, as used for the creation of the sensor waveguides and resonator structure) in conjunction III-V structures serving as active regions and associated electrodes, which may likewise be patterned using standard CMOS processes. Suitable photonic-component structures and manners of manufacturing same are well-known to those of ordinary skill in the art. If integrated as photonic-circuit components, the light source 404 and sensor 406 may directly couple to the input of the first waveguide 104 and the output of the second waveguide 106.

The system 400 further includes a computational processing facility 408 that processes the measured signal. The computational processing facility 408 may be implemented in analog or digital circuitry; if the latter, the electronic output of the detector 406 may be converted into a digital signal by an analog-to-digital converter (not shown). In some embodiments, the computational processing facility 408 is provided by a programmable processor (e.g., a field-programmable gate array (FPGA) or general-purpose central processing unit (CPU)) executing suitable software. Based on the measured Raman scattering signal(s) and their wavelength(s), the computational processing facility 408 may determine, e.g., in a binary fashion, whether a given analyte is present, or in the case of a tunable resonator or light source, which ones of multiple analytes are present. Further, the computational processing facility may determine the concentration of the analyte based on the intensity of the measured signal (in conjunction with calibration data), or a change in the concentration as reflected in temporally varying intensity.

To perform Raman spectroscopy on a sample, the sample may be dispensed onto the input waveguide and/or the ring resonator 108 of waveguide-based sensor 100 using a pipette, syringe, or similar tool, e.g., to form a drop on top of, or surrounding a portion of the top and side facets, of the surface-modified waveguide. Alternatively, the sample may be applied using microfluids. This is shown conceptually in FIG. 5, which provides a cut-away perspective view of a portion of the waveguide-based sensor 100 enclosed in a microfluid chamber 500 in accordance with various embodiments. The enclosed portion may be a portion of the input waveguide 104 (as depicted), the ring resonator 108, or both, depending on where the sample is to be applied. The microfluidic chamber 500 is formed on top of the photonic chip, enclosing the surface-modified portion of the waveguide 104, and includes a fluid inlet 502 and fluid outlet 504 that allow sample to be pumped through the chamber 500. Following application of the sample, the microfluidic chamber 500 can also be used to rinse and clean the sensor surface. The microfluidic chamber 500 may be formed, e.g., from a polymeric organosilicon such as polydimethylsiloxane (PDMS), or from some other suitable material. Methods for fabricating opto-fluidic chips including microfluidic components above a photonic circuit chip are known to those of ordinary skill in the art.

Waveguide-based Raman sensors as described herein lend themselves to the quick analysis of individual samples, e.g., for biological samples, immediately upon obtaining the sample from a patient at the point of care. On the other hand, they are also amenable to use in large numbers, e.g., integrated on a single chip in an array and optionally each provided with a microfluidic chamber holding the sample, for simultaneous measurements of multiple samples in high-throughput applications. In the latter case, multiple waveguide-based Raman sensors may receive input light from separate respective (e.g., on-chip) light sources, or from a single light source whose output is optically split between multiple channels including the multiple respective sensors. Each sensor may have its own respective associated detector. It is also possible to switch the output of a light source, and similarly the input of a detector, cyclically between multiple respective sensors for sequential measurements with the sensors; the time in between successive measurements with any given sensor can be used to load a new sample into the associated microfluidic chamber, or otherwise bring a new sample into contact with the sensor.

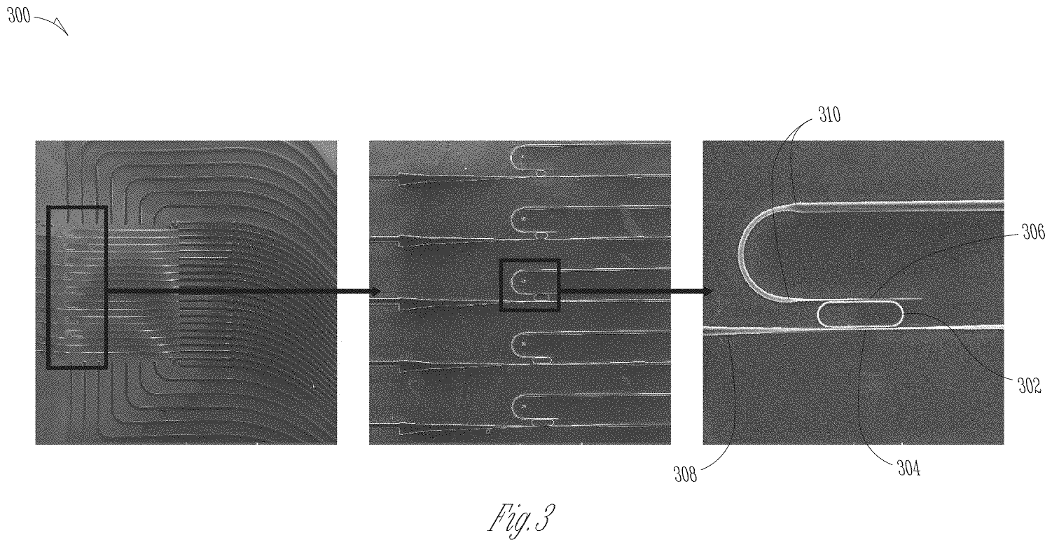

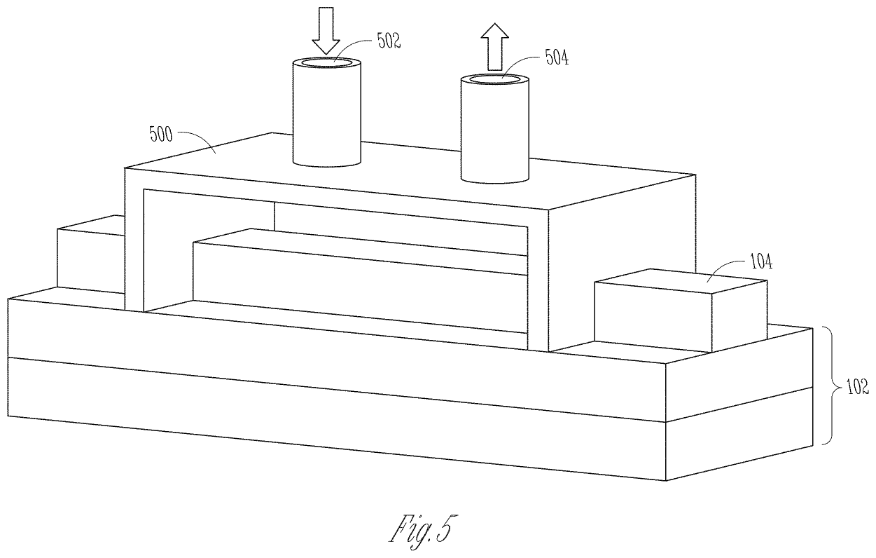

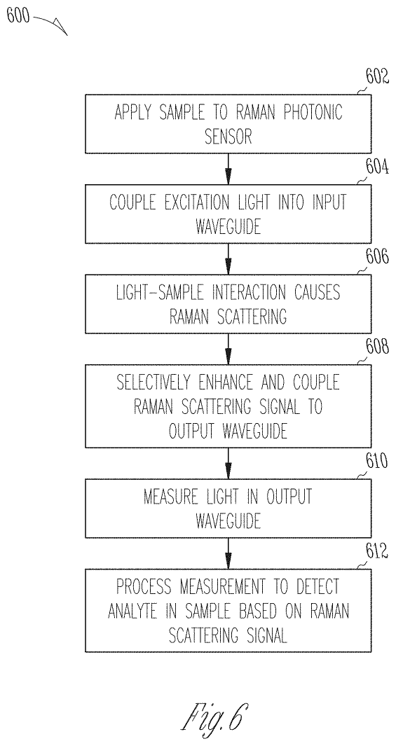

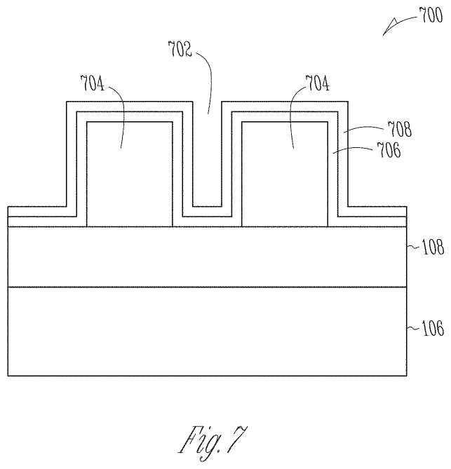

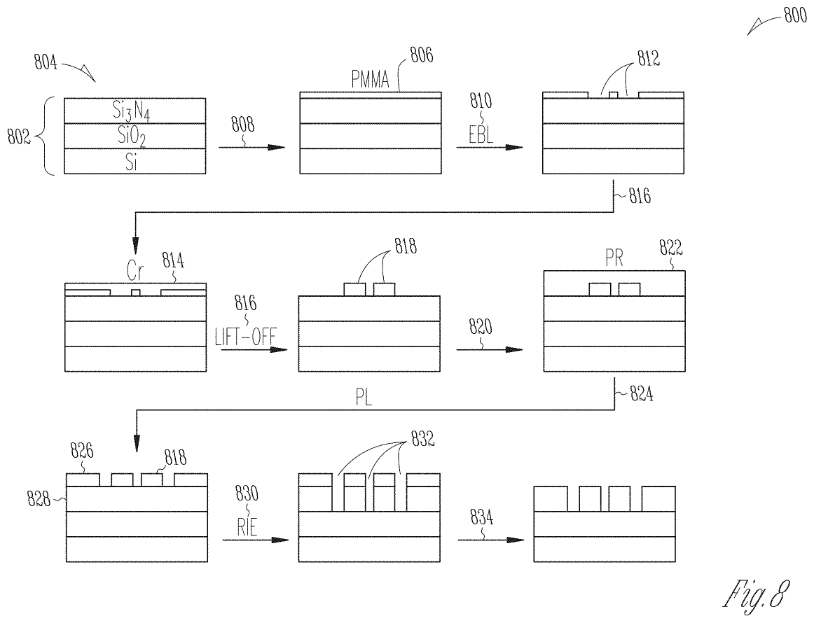

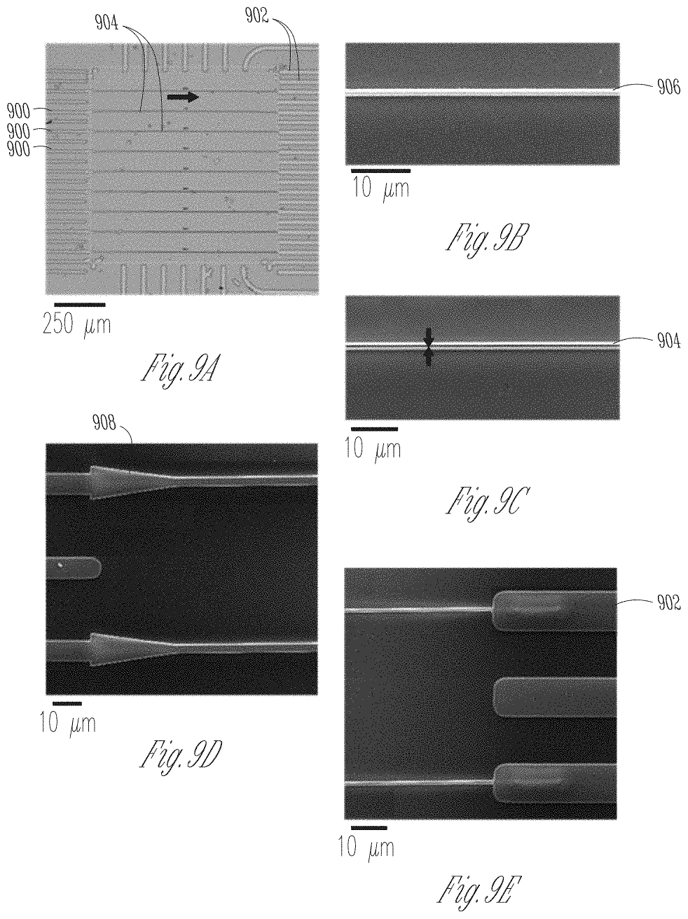

FIG. 6 is a flow chart of a method 600 for Raman-based sensing in accordance with various embodiments. The method 600 involves applying a chemical or biological sample to the input waveguide and/or resonator of the sensor, e.g., by dispensing a liquid sample from above onto the sensor or flowing the sample across the surface of the sensor (e.g., through a microfluidic chamber formed above the sensor) (act 602). In the case of a biological sample including a target molecule that binds to a biological probe disposed on the sensor surface, the sensor surface may be rinsed or otherwise cleaned following sample application and target binding. Light at an excitation wavelength is then coupled from the light source into the first waveguide (act 604). The optical mode launched into the waveguide may be a fundamental mode, and may be either transverse electric (TE) or transverse magnetic (TM). In certain embodiments, a TM mode is selectively excited in the waveguide, e.g., by virtue of the waveguide geometry and/or the light source. As explained below with reference to FIGS. 9A-9E, for strip waveguides 102, TM modes have been found to exhibit stronger evanescent fields, resulting in stronger interactions of the light with the surrounding sample and, consequently, larger signals. On the other hand, as explained with reference to FIGS. 10A-10E, for slot waveguides, the TE mode achieves significantly higher intensities in the slot than the TM mode, rendering the TE mode preferable to achieve greater light-analyte interaction. Thus, the polarization may be selected based at least in part on the type of waveguide utilized in the sensor.

Once a sample has been applied to the waveguide sensor, chemical and/or biological molecules in the sample can optically interact with the excitation light propagating in the first waveguide 104 and/or coupled into the optical resonator 108, causing Raman scattering (act 606). Raman scattering signals at the resonance(s) of the resonator(s) 108 will be enhanced and coupled to the output waveguide 106 (act 608). The resonator 108 is generally configured to selectively extract, in this manner, Raman scattering signals of a certain wavelength and associated with a given analyte. Light at the output of the second waveguide 106 is measured and thereby converted to electronic signals (act 610), which are then processed to determine whether, or in which amount, the analyte was present in the sample (act 612). That is, detection of a Raman scattering signal at the output of the second waveguide 106 is an indication that the sample contained the analyte for which the sensor was designed. The amount of analyte can be determined based on the intensity of the measured Raman scattering signal. Further, in embodiments in which the sensor is configured, e.g., with multiple resonators having different coupling wavelengths, to couple multiple Raman scattering wavelengths to the output waveguide 106, or in which the excitation wavelength or resonance wavelength are tunable, the signals may be processed to create a Raman scattering spectrum including multiple Raman wavelengths, based on which an analyte may be identified among multiple possible analytes.

In some embodiments, the sensitivity of the Raman photonic sensor is enhanced by replacing the portions of the strip waveguide 104 and/or the strip-like ring resonator 108 with slot waveguide structures whose sub-wavelength slot doubles as a fluidic channel for the sample. FIG. 7 shows a schematic cross section of such a slot waveguide 702, in accordance with various embodiments. The slot waveguide includes a vertical slot 702 centered between two waveguide strips 704. This slot 702 has a width that varies depending on the particular application, but is generally significantly smaller than the wavelengths at which the sensor is intended to operate. For example, in some embodiments, the width of the slot is 100 nm or less; the waveguide is, in this case, also referred to as a nano-slot waveguide. In other embodiments, the width of the slot is between 100 nm and 400 nm. The overall waveguide dimensions may be similar to those of the strip waveguide 104. In the depicted example, the surface of the sensor 700 is coated with a thin adhesion layer 706 and a biological probe layer 708 to render the slot waveguide suitable for detecting biological analytes. As can be seen, these layers may be disposed over the top and side walls of the waveguide strips 704, thus lining the walls of the slot 702. (Note that FIG. 7 is a conceptional depiction and not drawn to scale. The adhesion and probe layers 706, 708 may, in some embodiments, have thicknesses of only a few nanometers, or even sub-nanometers, much smaller than the width of the slot 702.)

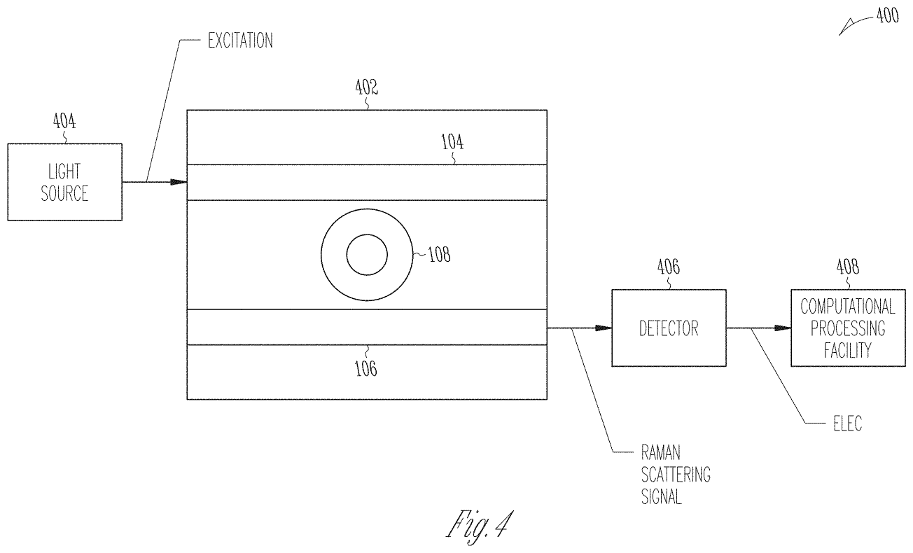

FIG. 8 is a sequence of cross-sectional views of a slot waveguide, as may be used in Raman photonic sensors as described herein, illustrating an example method 800 of manufacturing the slot waveguide, in accordance with various embodiments. In general, the slot waveguide, along with any strip waveguides at its input and output and/or associated couplers, is created using a multi-step fabrication process, including, e.g., thin-film deposition, lithography, and selective plasma etching. Various material platforms, e.g., as mentioned above with reference to FIG. 1, may be used for the layered wafer 802 in which the waveguide structures are formed. To provide just one example, the waveguide structures may be created in the silicon nitride device layer of a Si₃N₄-on-insulator layered wafer, which itself may be made by plasma-enhanced chemical vapor deposition (PECVD) to first form a silicon dioxide layer (e.g., 2-5 μm thick) on a silicon substrate, and thereafter to deposit a Si₃N₄ layer (e.g., 400 nm thick) on the silicon dioxide layer, using dilute SiH₄ and N₂ precursor gases.

In the depicted example process, starting with a layered wafer 802 (at 804), a positive electron beam resist layer 806 (e.g., a double layer of 495K and 950K PMMA A4) is spun on the layered wafer (at 808), and then patterned using electron beam lithography (EBL) (at 810). The portions of the layer 812 that are removed in the process define the slot waveguide. A mask layer 814, e.g., made of chromium (Cr) and about 50 nm thick, is deposited over the patterned substrate, for instance, using electron beam evaporation (at 816). In a lift-off process (at 816), the resist layer 806, along with the portions of the Cr mask layer 814 deposited thereon, is then removed, leaving a patterned Cr mask 818 defining and covering only the regions of the slot waveguide. The device is then (at 820) spin-coated with a layer of (e.g., S1818) photoresist (PR) 822. The photoresist layer 822 is patterned by photolithography (at 824) to define, e.g., the wider strip-waveguide portions of the input and output waveguides and the associated tapers (e.g., as shown in FIG. 3), aligned with the EBL-created waveguide slot pattern. The patterned photoresist 826 and Cr mask 818 together expose the surface of the wafer device layer 828 in the regions of the waveguide slot and of channels to be etched into the device layer around and defining the waveguide structures. These devices patterns are transferred into the (e.g., Si₃N₄) device layer by selective reactive ion etching (RIE) (at 830), creating channels 832 (including the waveguide slot) in the device layer 828. The Cr mask 818 and patterned photoresist 826 are then removed, using a remover based on, e.g., ceric ammonium nitrate etchant solution and 1-methyl-2-pyrrolidon (NMP). The final structure may include the slot waveguide sections of the input and output waveguides and the slot waveguide ring resonator, input and output strip waveguides connecting to the slot waveguide sections, and tapers. It has been experimentally verified that the described process can achieve clearly defined structures with a smooth top surface, indicating uniform etching with no damage introduced during the RIE process.

FIGS. 9A-9E are top views of example nano-slot waveguide structures in accordance with an embodiment, individually drawn to scale based on optical microscopy and scanning electron microscopy images. FIG. 9A shows the array of the input and output strip waveguides 900, 902 and the nano-slot waveguides 904 in the center of the devices. FIGS. 9B and 9C show, enlarged, details of a reference strip waveguide 906 and a nano-slot waveguide 904, respectively. The example strip waveguide in FIG. 9B has a width of 0.8 μm, and the example nano-slot waveguide in FIG. 9C has a slot width of 100 nm centered between two 0.4 μm wide Si₃N₄ strips. FIG. 9D shows, at a higher magnification, the input region, showing a tapered input coupler 910 connecting the input waveguide 900 to the slot waveguide 904. FIG. 9E shows the output region, highlighting the transition from the nano-slot waveguide 904 to a wider output waveguide 902. Accurate alignment between the slot waveguide 904 and the input and output waveguides 900, 902, in a conjunction with the taper coupler 908, ensure the efficient excitation of a nano-slot waveguide mode.

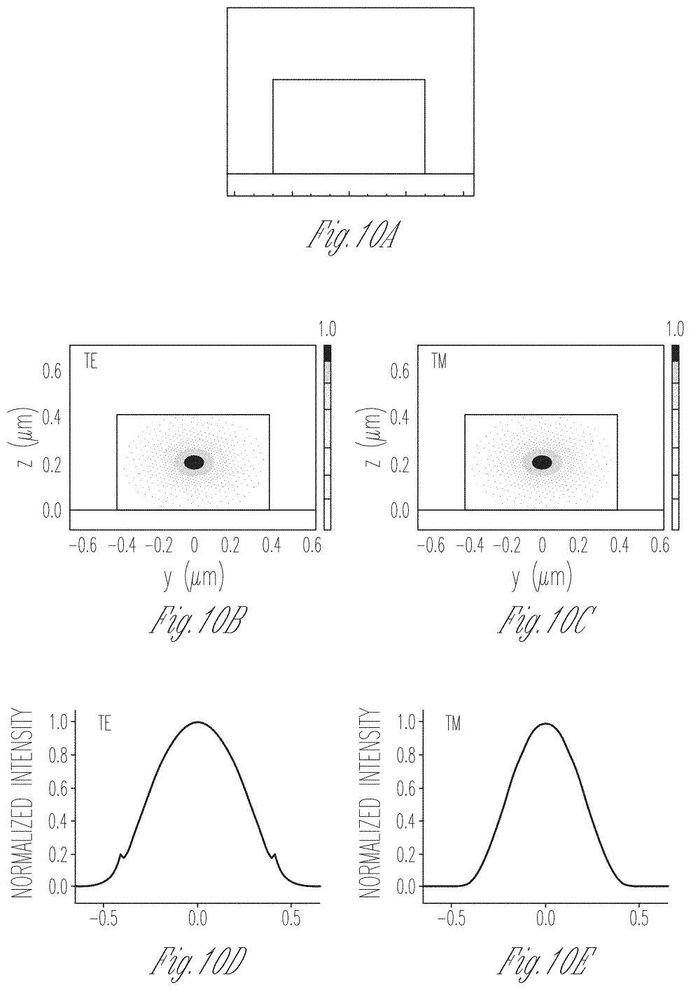

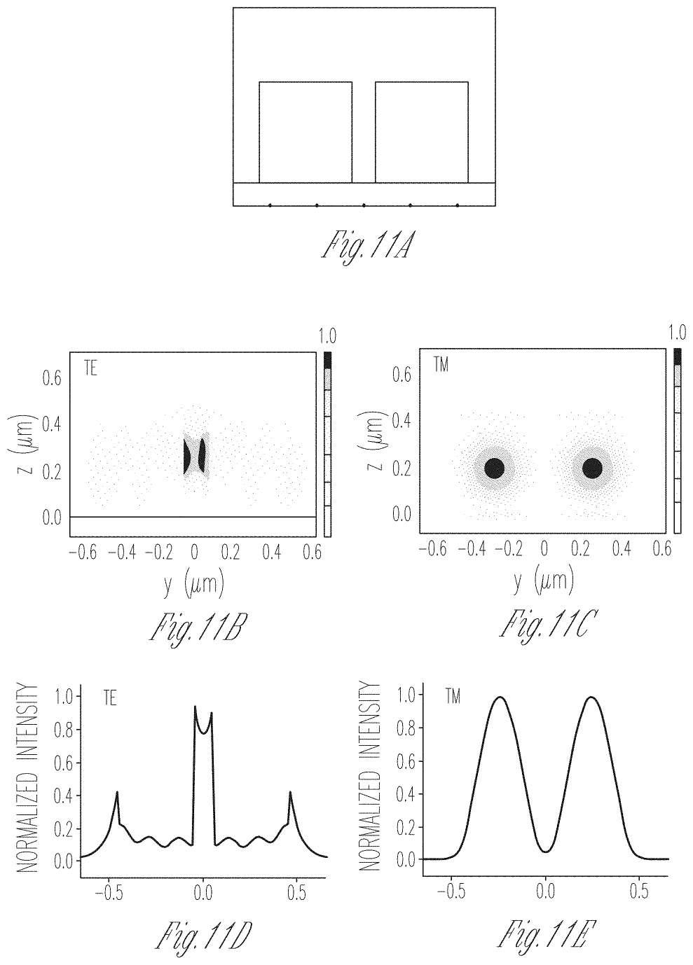

FIGS. 10A-11E illustrate the sensitivity enhancement that can be achieved with nano-slot waveguides, as was evaluated computationally based on optical mode profiles simulated by two-dimensional finite difference method (FDM) for both strip and nano-slot waveguides. The device dimensions of the slot waveguide for the simulation were those shown in FIGS. 9A-9E. The waveguides were formed in Si₃N₄ on SiO₂. Refractive indices of 2.1 for the Si₃N₄ waveguide and of 1.45 for the SiO₂ undercladding were used in the simulations, and a 2 μm×0.8 μm excitation source was selected.

FIG. 10A provides a cross-sectional view of an example strip waveguide as may be used in biosensors in accordance with various embodiments. For purposes of the simulation, the strip waveguide is 800 nm wide and 400 nm tall. FIGS. 10B and 10C show example optical modes in the strip waveguide for transverse electric (TE) and transverse magnetic (TM) polarizations, respectively. As can be seen, for both TE and TM polarized light, an elliptical fundamental mode is obtained at the center of waveguide. FIGS. 10D and 10E are example one-dimensional profiles of the field distribution associated with the optical modes of FIGS. 10B and 10C, respectively, taken along the y-axis. As can be seen, most of the light is contained inside the Si₃N₄ strip. Based on quantitative analysis of the simulated modes, the TE polarized waveguide mode has about 3.4% of its intensity in the evanescent wave outside the waveguide. For the TM polarized waveguide mode, the evanescent portion is only 0.2%.

FIG. 11A is a cross-sectional view of a nano-slot waveguide as may be used in biosensors in accordance with various embodiments. As simulated, the nano-slot waveguide is formed of two 400 nm wide waveguide strips separated by a 100 nm space, and is 400 nm tall. FIGS. 11B and 11C show example optical modes in the nano-slot waveguide of FIG. 11A in two dimensions for transverse electric (TE) and transverse magnetic (TM) polarizations, respectively. As can be seen in FIG. 11B, for TE polarization, the field is highly concentrated in the center of the 100 nm nano-slot region, which, in use, can serve as the fluidic channel to be filled with the sample to be analyzed. On the other hand, for TM polarization, as shown in FIG. 11C, only a small portion of the field extends outside the two waveguide strips. FIGS. 11D and 11E are example one-dimensional profiles of the field distribution associated with the optical modes of FIGS. 11B and 11C, respectively. For the TE polarized mode, the nano-slot waveguide has a 50.5% of the light intensity confined in the slot region. By contrast, for the TM polarized mode, the portion of the field extending outside of the waveguide strips is merely 5.9%, which is similar to the TM mode of a single-strip waveguide as shown in FIG. 10A.

Compared to the counterpart single-strip waveguide, the TE mode of the nano-slot waveguide revealed a fourteenfold (14×) enhancement of the optical intensity. This enhanced intensity, in conjunction with the direct overlap between the fluidic channel, where the sample is applied, and the waveguide mode, can significantly improve the overall sensitivity due to the increased light-analyte interaction in the slot region. Beneficially, unlike methods that improve the optical sensitivity by decreasing the waveguide thickness, the nano-slot waveguide converts guided light into a nano-scale optical probe without a reduction in coupling efficiency or increase in the optical loss. Sensitivity enhancement with slot waveguides can be applied to Raman spectroscopy as described herein, but is also applicable to other spectroscopic methods, including infrared absorption spectroscopy and fluorescence spectroscopy.

Although embodiments have been described with reference to specific example embodiments, it will be evident that various modifications and changes may be made to these embodiments without departing from the broader scope of the invention. Accordingly, the specification and drawings are to be regarded in an illustrative rather than a restrictive sense.

What is claimed is:

1. An analyte sensing system comprising:
a photonic sensor comprising a substrate and, disposed on the substrate, first and second optical waveguides and an optical ring resonator coupling the first optical waveguide to the second optical waveguide, at least a portion of the first optical waveguide or the optical ring resonator being exposable to a sample including an analyte;
a light source configured to couple light at an excitation wavelength into the first optical waveguide; and
a detector configured to measure light at an output of the second optical waveguide,
wherein the optical ring resonator is configured to resonantly enhance, and selectively couple into the second optical waveguide, a Raman scattering signal generated by interaction of the light at the excitation wavelength with the analyte.

2. The analyte sensing system of claim 1, wherein the analyte is a chemical analyte.

3. The analyte sensing system of claim 1, wherein the analyte is a biological analyte, and wherein the at least a portion of the first optical waveguide or the optical ring resonator comprises, on a surface of the first optical waveguide or the optical ring resonator, a biological probe that specifically binds to the biological analyte.

4. The analyte sensing system of claim 3, wherein the biological probe is disposed on an adhesion layer coating the at least a portion of the first optical waveguide or the optical ring resonator.

5. The analyte sensing system of claim 3, wherein the biological probe comprises at least one of a protein or a polynucleic acid.

6. The analyte sensing system of claim 3, wherein the biological probe is specific for a coronavirus.

7. The analyte sensing system of claim 1, wherein a refractive index and a circumference of the optical ring resonator are configured such that an optical path length of a round trip around the optical ring resonator corresponds to an integer multiple of a wavelength of the Raman scattering signal.

8. The analyte sensing system of claim 7, wherein the optical ring resonator comprises an electro-optic or thermo-optic modulator that configures the refractive index of the optical ring resonator.

9. The analyte sensing system of claim 1, wherein at least one of the first optical waveguide or the optical ring resonator has a slot waveguide structure.

10. The analyte sensing system of claim 1, further comprising:
a computational processing facility configured to process a signal received from the detector to detect the analyte based on the Raman scattering signal.

11. The analyte sensing system of claim 10, further comprising a microfluidic chamber enclosing the at least a portion of the first optical waveguide or the optical ring resonator, and configured to bring the sample in contact with the at least a portion of the first optical waveguide or the optical ring resonator.

12. The analyte sensing system of claim 1, wherein at least one of the light source or the detector is monolithically integrated with the photonic sensor on the substrate.

13. A method for sensing an analyte with a photonic sensor comprising, disposed on a substrate, first and second optical waveguides and an optical ring resonator coupling the first optical waveguide to the second optical waveguide, the method comprising:
applying a sample including the analyte to the first optical waveguide or the optical ring resonator;
coupling light at an excitation wavelength into the first optical waveguide, thereby causing a Raman scattering signal to be generated from interaction of the light with the analyte;
using the optical ring resonator to resonantly enhance and selectively couple the Raman scattering signal into the second optical waveguide; and
detecting the Raman scattering signal at an output of the second optical waveguide.

14. The method of claim 13, wherein the analyte is a biological analyte and the photonic sensor comprises a biological probe disposed on at least one of the first optical waveguide or the optical ring resonator, and wherein applying the sample causes the biological analyte to specifically bind to the biological probe.

15. The method of claim 13, wherein resonantly enhancing and selectively coupling the Raman scattering signal into the second optical waveguide comprises tuning a resonance wavelength of the optical ring resonator to a wavelength of the Raman scattering signal.

16. The method of claim 13, further comprising tuning the excitation wavelength to a difference between a wavelength of the Raman scattering signal and a Raman wavelength shift associated with the analyte.

17. A photonic biosensor comprising:
a substrate;
disposed on the substrate, first and second optical waveguides and an optical ring resonator coupling the first optical waveguide to the second optical waveguide; and
a biological probe layer disposed on at least a portion of the first optical waveguide or the optical ring resonator, the biological probe layer being exposable to a sample and comprising a biological probe that specifically bonds to a biological analyte,
wherein the optical ring resonator is configured to resonantly enhance, and selectively couple into the second optical waveguide, a Raman scattering signal generated by interaction of the biological analyte, when bound to the biological probe, with light coupled into the first optical waveguide.

18. The photonic biosensor of claim 17, wherein the biological probe is disposed on an adhesion layer coating the at least a portion of the first optical waveguide or the optical ring resonator.

19. The photonic biosensor of claim 17, wherein the biological probe comprises at least one of a protein or a polynucleic acid.

20. The photonic biosensor of claim 17, wherein the biological probe is specific for a coronavirus.
